(19) United States
(12) Patent Application Publication
(10) Pub. No.: US 2024/0029574 A1
(43) Pub. Date: Jan. 25, 2024

(54) AIRCRAFT, PROCESSOR, AND FLIGHT CONTROL METHOD

(71) Applicant: AERONEXT INC., Tokyo (JP)

(72) Inventor: Yoichi SUZUKI, Tokyo (JP)

(21) Appl. No.: 18/253,374

(22) PCT Filed: Nov. 27, 2020
(86) PCT No.: PCT/JP2020/044382

§ 371 Date: May 17, 2023

(51) Int. Cl. G08G 5/02; G08G 5/00; G05D 1/10

(52) U.S. Cl. CPC G08G 5/025; G08G 5/0069; G08G 5/0004; G05D 1/101; B64U 10/16

(57) ABSTRACT

An aircraft that flies autonomously using GNSS, etc., and that can improve the reliability of its flight while minimizing cost increases. An aircraft flying autonomously on a designated route, and when the aircraft is not continuing its autonomous flight on the designated route, with a processor which controls the flight of the aircraft based on information about the landing site acquired externally by an external information acquisition device. The external information acquisition device is a sensor. The sensor is an image sensor. The external information acquisition device is a beacon device. The processor executes a safe landing mode in which flight control is performed based on a flight route to acquire information about the landing site.

### TECHNICAL FIELD

This invention relates to aircraft, processors, flight control methods, programs, and flight assistance equipment.

### BACKGROUND ART

In recent years, research and demonstration tests have been conducted toward the practical application of services using flying vehicles such as drones and unmanned aerial vehicles (UAVs; hereinafter collectively referred to as “aircraft”). In implementing services such as home delivery and inspection, it is desirable for flight and takeoff/landing to be performed automatically. In view of this situation, Patent Literature 1 discloses landing equipment in which aircraft can land autonomously.

More specifically, Patent Literature 1 discloses landing equipment equipped with markers to assist aircraft in autonomous landing.

### PRIOR ART LIST

### Patent Literature

[Patent Literature 1] US20160122038A1

### SUMMARY OF THE INVENTION

### Technical Problem

In Patent Literature 1, it is possible to provide landing equipment that can realize low-cost and efficient autonomous landing of aircraft.

However, there is no guarantee that autonomous flight by Global Navigation Satellite Systems (GNSS) or the like (satellite positioning systems) can always be performed with the same accuracy. Depending on the positioning and environmental conditions between the aircraft and the satellites, there may be a shortage of satellite coverage, making accurate self-position estimation difficult, or errors may occur due to solar activity such as solar flares. Under such circumstances, in an autonomous landing using the landing equipment of Patent Literature 1, the aircraft flying autonomously by GNSS or other means may not be able to move accurately to a distance where it can recognize the marker, and thus may not be able to perform an autonomous landing satisfactorily.

As a solution to the difficulty of autonomous flight using GNSS or the like, guidance by a ground-based control system and a real-time mapping system using a lidar or the like equipped on the aircraft are well-known, but they increase operating costs due to the maintenance of ground facilities, maintenance, etc., and increase the weight of the aircraft. Therefore, these systems are not optimal for the implementation and continuity of services.

Therefore, one object of this invention is to provide aircraft or the like which fly autonomously using GNSS, etc., and which can improve the reliability of flight with a minimum increase in cost.

### Technical Solution

According to the invention, an aircraft flying autonomously on a designated route can be provided with a processor that controls the flight of the aircraft based on information about the landing site obtained externally by an external information acquisition device when the aircraft is not continuing autonomous flight on the designated route.

### Advantageous Effects

According to the invention, it is possible to provide an aircraft, which flies autonomously using GNSS or the like, and which can improve the reliability of flight with a minimum increase in cost.

### BRIEF DESCRIPTION OF THE DRAWINGS

FIG. 1 shows a schematic view of the invention's flight assistance equipment from the top.

FIG. 2 shows a side view of the flight assistance equipment of FIG. 1.

FIG. 3 shows a view of the direction indicated by the auxiliary sign of the flight assistance equipment of FIG. 1.

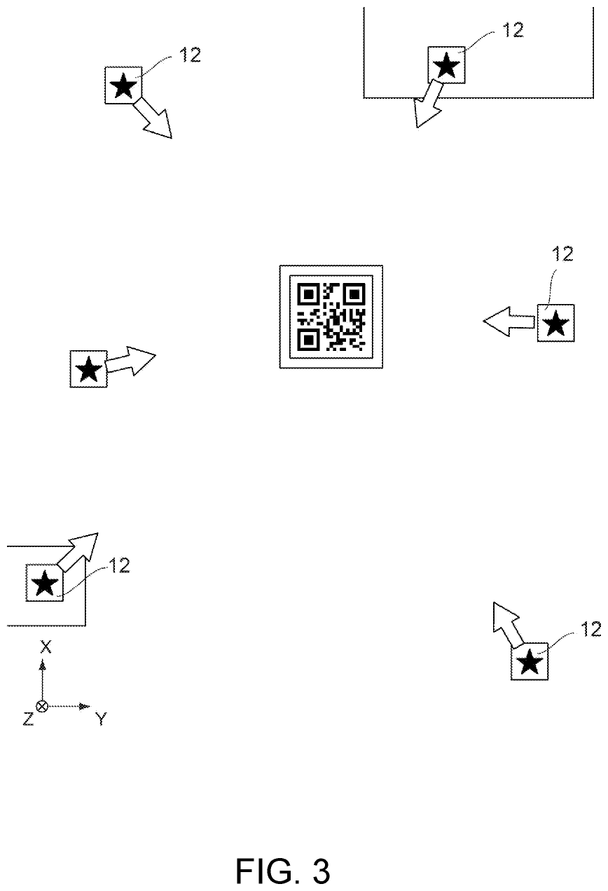

FIG. 4 shows a top view of the aircraft of FIG. 1.

FIG. 5 shows a side view of the aircraft of FIG. 4.

FIG. 6 shows a functional block diagram of the aircraft of FIG. 4.

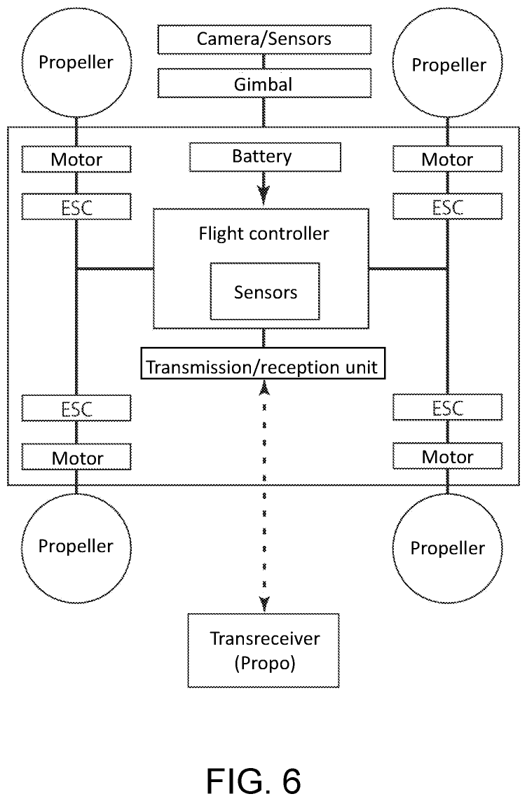

FIG. 7 shows a top view of the auxiliary sign of the flight assistance equipment of the invention.

FIG. 8 shows an isometric projection of the auxiliary sign of FIG. 7.

FIG. 9 shows a top view of the aircraft in this invention when it is being guided to a landing site.

FIG. 10 shows a side view of the state in FIG. 9.

FIG. 11 shows another top view of the aircraft in the invention when it is being guided to the landing site.

FIG. 12 shows a side view of the state in FIG. 11.

FIG. 13 shows another side view of the installation of an auxiliary sign.

FIG. 14 shows a schematic diagram of the aircraft in the invention when it is in safe landing mode.

FIG. 15 shows an example of an aircraft's flight route in the invention's safe landing mode.

FIG. 16 shows an example of an aircraft's flight route in the invention's safe landing mode.

FIG. 17 shows an example of an aircraft's flight route in the invention's safe landing mode.

FIG. 18 shows an example of an aircraft's flight route in the invention's safe landing mode.

FIG. 19 shows a side view of another flying vehicle in the invention's flight assistance equipment.

FIG. 20 shows a schematic view of poles and wires from the top.

### DETAILED DESCRIPTION OF THE EMBODIMENTS

The following is a list and description of the contents of this embodiment of the invention. The aircraft, processor, flight control method, program, and flight assistance equipment according to this embodiment of the invention comprise the following:

[Item 1]

An aircraft flying autonomously on a designated route, comprising a processor that performs flight control of the aircraft based on information about a landing point acquired from an external information acquisition device when the aircraft is not continuing autonomous flight on the specified route.

[Item 2]

The aircraft according to item 1,
wherein the external information acquisition device is a sensor. [Item 3]

The aircraft according to item 2,
wherein the sensor is an image sensor.

[Item 4]

The aircraft according to item 1,
wherein the external information acquisition device is a beacon device.

[Item 5]

The aircraft as in any one of items 1 to 4,
wherein the processor executes a safe landing mode in which flight control is performed based on the flight route for acquiring information on the landing site.

[Item 6]

The aircraft as in any one of items 1 to 4,
wherein the processor recognizes the information on the landing site as the information on the landing site on the designated route during normal times, and wherein the processor recognizes the information on the landing site as information on an emergency landing site different from the landing site on the designated route in the safe landing mode.

[Item 7]

The aircraft as in any one of items 1 to 6,
wherein the aircraft transmits the information on the landing site to another aircraft or to a management server that supports autonomous flight for the aircraft.

[Item 8]

A processor mounted on an aircraft flying autonomously on a designated route,
wherein the processor performs flight control of the aircraft based on information on the landing site obtained externally by an external information acquisition device when the autonomous flight over the designated route is not continued.

[Item 9]

A method for flight control of an aircraft flying autonomously on a designated route,
comprising a step of controlling the flight of the aircraft based on information on the landing site acquired externally by an external information acquisition device when the aircraft is not continuing autonomous flight on the designated route.

[Item 10]

A program for executing a flight control method on an aircraft flying autonomously on a designated route,
wherein the flight control method comprises a step of performing flight control of the aircraft based on information on the landing site obtained externally by an external information acquisition device when the aircraft is not continuing autonomous flight on the designated route.

[Item 11]

Flight assistance equipment for an aircraft flying autonomously over a designated route, comprising an auxiliary sign that provides information on the landing site.

### DETAILS OF EMBODIMENTS ACCORDING TO THIS INVENTION

An aircraft according to this embodiment of the invention is described below with reference to the drawings.

### Details of the First Embodiment

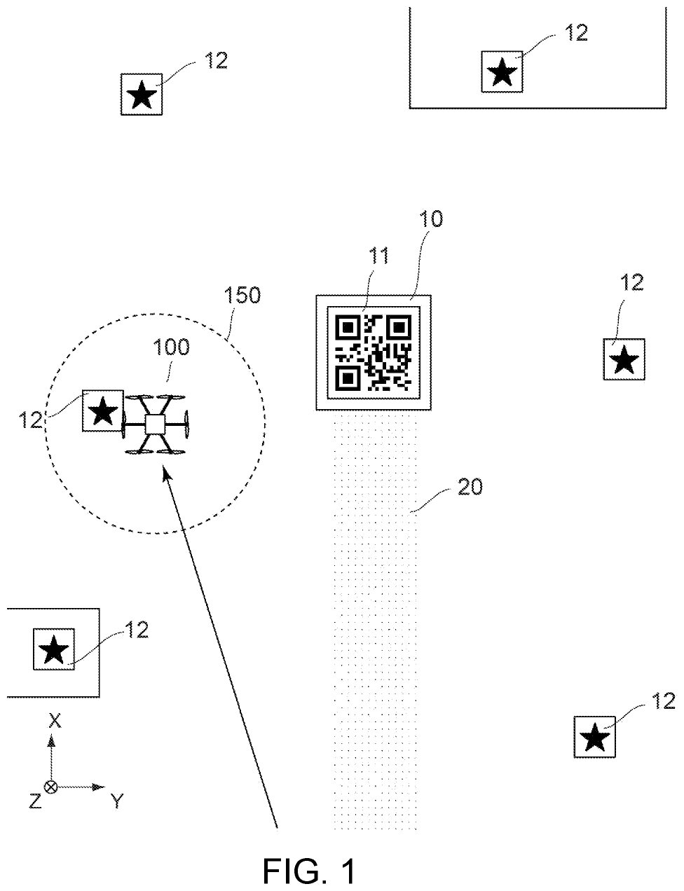

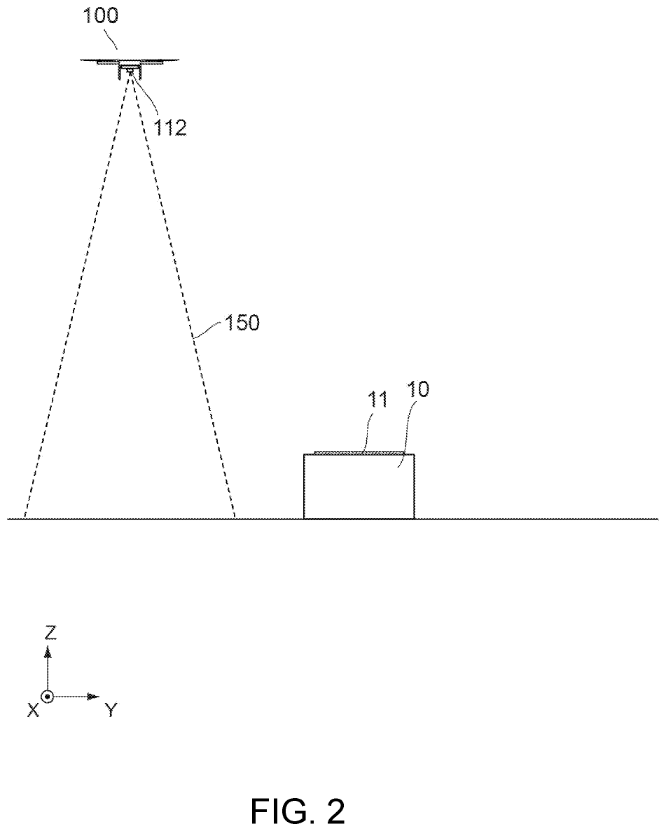

As shown in FIGS. 1 and 2, the auxiliary system according to this embodiment has an auxiliary sign 12, such as a figure, lettering, etc., represented by a plate, sheet, display, structure, etc., and an auxiliary sign capturing sensor (hereinafter referred to as an external information capturing device) 112 installed on an aircraft 100 that is capable of capturing the auxiliary sign 12. The auxiliary sign 12 is placed on a designated route 20 of the aircraft 100, or a plurality of auxiliary signs 12 are placed outside the designated route to assist the flight of the aircraft 100. The auxiliary signs 12 shown in the figure are drawn as a unified black star in order to clarify their positions, etc., and the figure does not show changes in figures and letters due to differences in the information indicated by each of the multiple auxiliary signs 12.

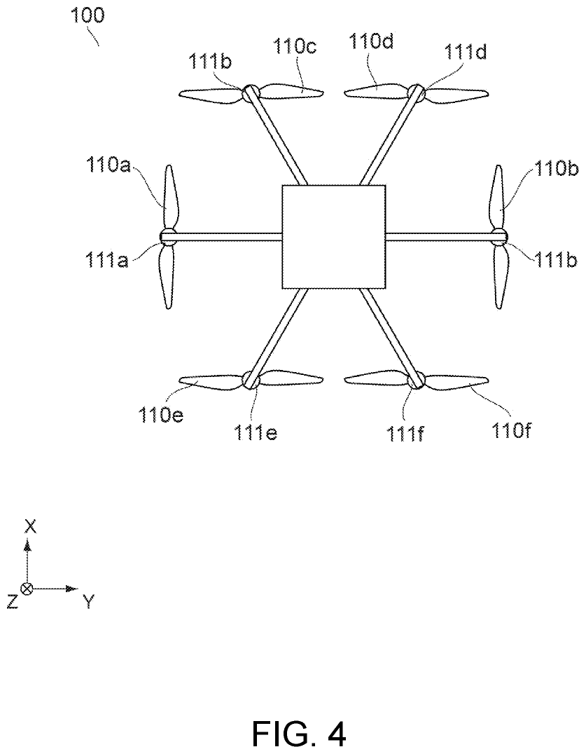

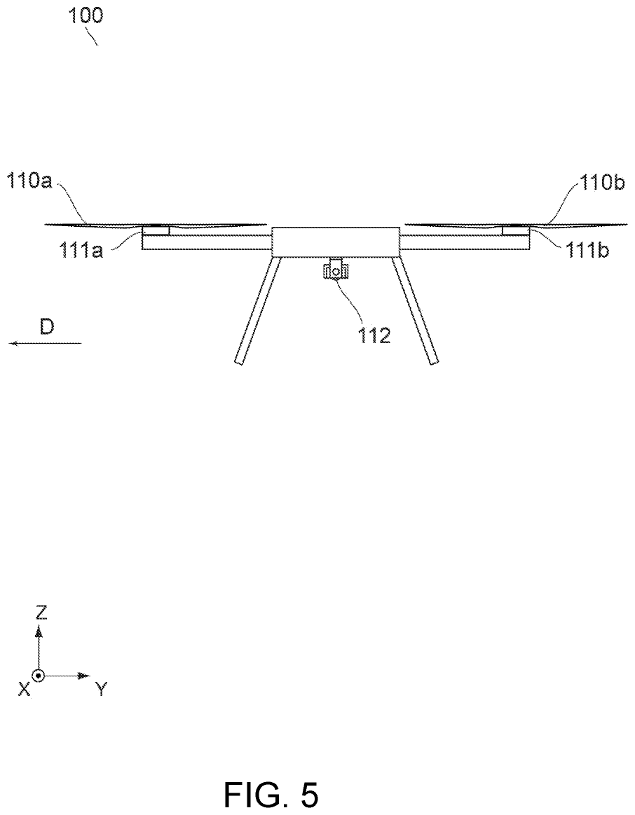

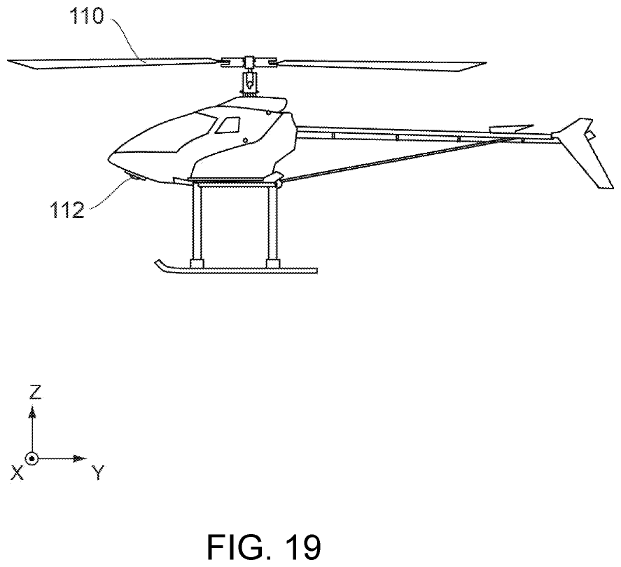

The aircraft 100 is equipped with at least a propeller 110, a motor 111, and other elements for flight, and energy (e.g., secondary batteries, fuel cells, fossil fuel, etc.) to operate them. The aircraft should preferably be a multicopter, as shown in FIG. 4 or FIG. 5, with multiple propellers and motors, or a single-rotor helicopter, as shown in FIG. 19, which does not require a runway or other large area.

The sensor 112 is installed in connection with the aircraft 100 and at any location that is capable of capturing at least the exterior from the aircraft during flight. The angle of installation of the sensor 112 is determined by the location of the auxiliary sign 12 to be used, the altitude at which the aircraft will be used, and the range of capture of the sensor 112. The sensor may be connected to the aircraft so that it can be displaced independently of the inclination of the aircraft in order to set the sensor in a given orientation in both conditions when the aircraft is tilted forward or when hovering in no wind and the aircraft is not tilted. For example, by using a camera gimbal or similar device, the orientation of the sensor can be kept constant without being affected by changes in the angle of the aircraft.

The sensor 112 is a detector that can capture the auxiliary sign 12 while the aircraft is in the air. For example, an optical sensor, such as a digital camera or an infrared camera, is capable of visually recognizing the auxiliary signs 12. It may also be used in conjunction with a distance measuring device such as millimeter wave radar to efficiently capture the auxiliary signs.

The aircraft 100 shown in the figure is depicted in simplified form to facilitate the explanation of the structure of the invention, and the detailed configuration of the control unit, for example, is not shown.

The aircraft 100 is moving forward in the direction of arrow D (−YX direction) in the figure (see below for details).

In the following explanation, the terms may be used according to the following definitions. Forward/backward: +Y and −Y; up/down (or vertical): +Z and Z; left/right (or horizontal): +X and −X; forward (forward direction): −Y; backward (backward direction): +Y; up (upward): +Z; down (downward): −Z

The propeller 110 rotates under the output from the motor 111. The rotation of the propeller 110 generates propulsive force to take the aircraft 100 off from its starting point, move it, and land it at its destination. The propeller 110 can rotate to the right, stop, and rotate to the left.

The propeller 110 provided by the aircraft of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the vane can be selected as appropriate to optimize the dynamic aerodynamic characteristics of the vane, such as increasing lift and thrust and reducing drag.

The propeller provided by the aircraft of the invention may be, but is not limited to, fixed pitch, variable pitch, or a mixture of fixed and variable pitch.

The motor 111 produces rotation of the propeller 110; for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The aircraft 100 determines the number of revolutions of each motor and the angle of flight according to the wind speed and direction by means of a flight controller, radio, or other device. This allows the aircraft to move up and down, accelerate and decelerate, and change direction.

The aircraft 100 can fly autonomously according to routes and rules set in advance or during the flight, or by using a radio to control the aircraft.

The aircraft described above has the functional blocks shown in FIG. 2. The functional blocks in FIG. 2 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from a camera and sensors may be directly transmitted to and stored in the memory. For example, still and moving image data captured by a camera or other device is recorded in the internal or external memory.

The processing unit includes a control module configured to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion θx, θy and θz). The control module can control one or more of the states of a mounting part and sensors.

The processing unit is in communication with a transmission/reception unit configured to transmit and/or receive data from one or more external devices (e.g., terminals, displays, or other remote controllers). The transmitter/receiver can use any suitable means of communication, such as wired or wireless communication. For example, the transmission/reception unit can use one or more of the following: local area network (LAN), wide area network (WAN), infrared, wireless, WiFi, point-to-point (P2P) network, telecommunications network, or cloud communications. The transmission/reception unit can transmit and/or receive one or more of the following: data acquired by sensors, processing results generated by the processing unit, predetermined control data, and user commands from a terminal or remote controller.

Sensors in this embodiment can include inertial sensors (accelerometers, gyroscopes), GPS sensors, proximity sensors (e.g., lidar), or vision/image sensors (e.g., cameras).

The processing unit is also equipped with a processing system to reflect optical and other information obtained from the auxiliary signs 12 captured by the sensor 112 in flight control.

Figures and letters indicated by the auxiliary sign 12 should be of a shape that is easily distinguished from other objects (natural or generally outdoor objects) and captured when viewed from the sky in order to improve the accuracy and speed of capture. For example, a single circle or square is more likely to be misidentified than other complex figures, 2D codes, etc., because they are common shapes of structures, buildings, etc., as seen from the sky.

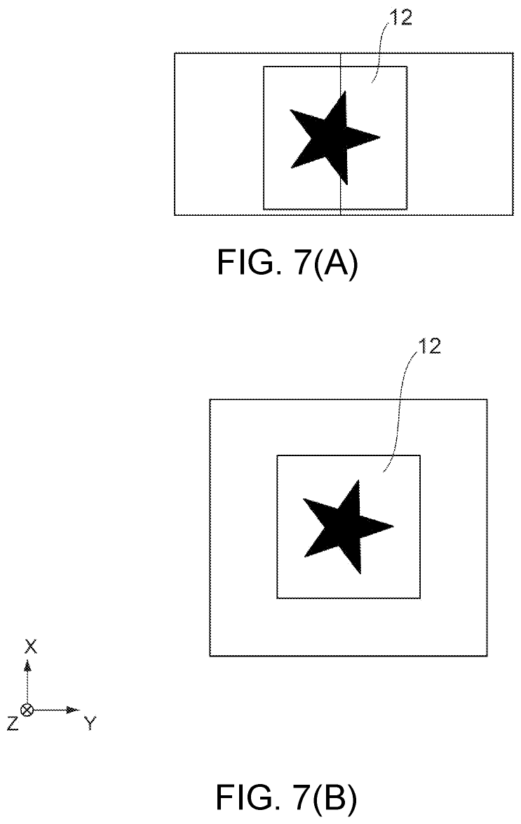

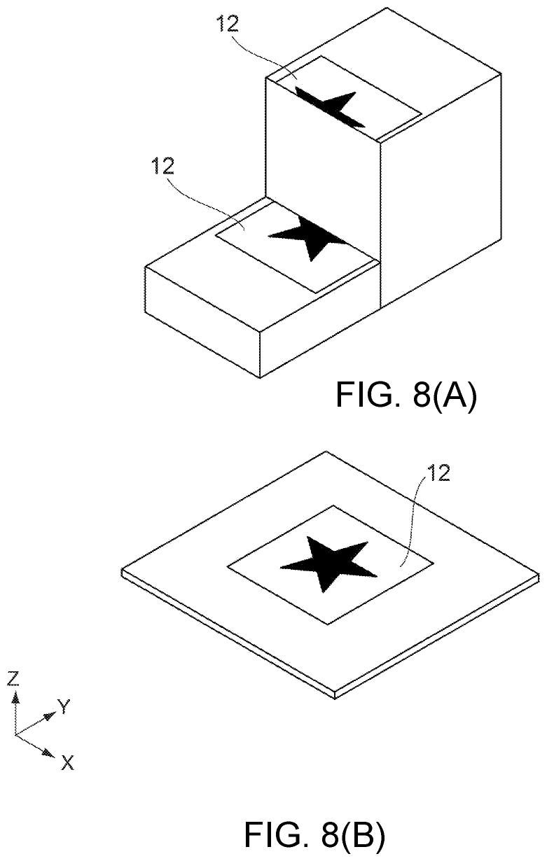

The auxiliary sign 12 is represented in such a way that the content of the sign can be captured from the aircraft 100 flying in the air. When the camera provided by the aircraft is looking directly down, the auxiliary sign 12 is preferably displayed in such a way that it can not only be accurately captured from directly above (in the +Z direction), as shown in FIG. 7 and FIG. 8B, but can also be captured even if not directly above. It may be provided on a stepped configuration as shown in FIG. 7, on a flat configuration as shown in FIG. 8B, or on any other configuration that is sloped, for example, toward the specified route of the designated route.

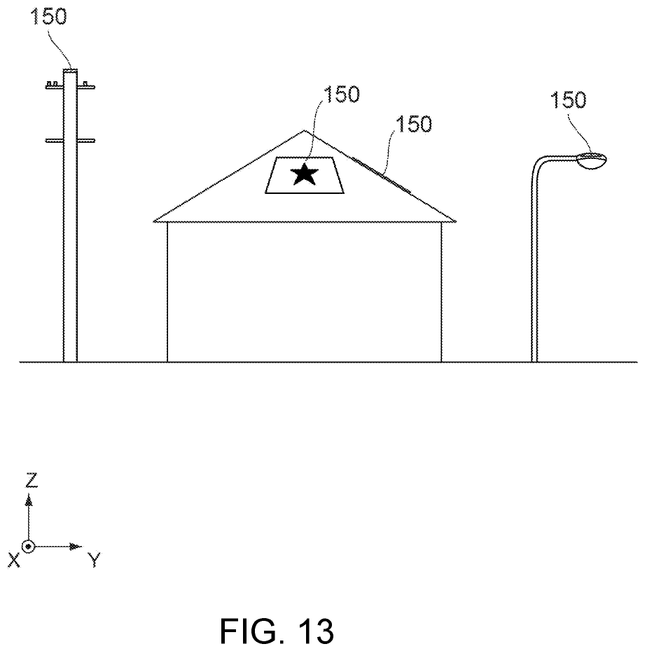

The 12 auxiliary signs can be placed on the ground or painted with paint in level areas. In locations where there are buildings or structures, it is desirable to install the sign at an elevated location where there are few obstructions in the sky so that it can be easily captured from aircraft in flight. For example, as shown in FIG. 13, the roof or rooftop of a building, the top of a utility pole or street lamp may be suitable locations. However, the installation location is not limited to these locations as long as it can be placed where it can be captured by the aircraft.

Each of the 100 aircraft using the auxiliary sign 12 flies at its own altitude, and the altitude to be used as a route is set in advance so as not to cause a collision or other accident. Therefore, the size of the auxiliary sign 12 is determined so that it will not be difficult for the aircraft to be detected by the sensor 112 at the altitude at which it will be used. For example, even if the altitude of the aircraft is set at 50 meters, the minimum size of the auxiliary sign 12 will be different for an aircraft with a 50 mm focal length camera and an aircraft with a 400 mm focal length camera, because the minimum size of the auxiliary sign 12 that can be captured is significantly different.

The auxiliary signs 12 are provided outside of a landing port or emergency landing site equipped with landing marker 11 (hereinafter collectively referred to as landing site 10), for example, and around the designated route 20 or on the route 20 of aircraft 100. The direction of travel can be determined by the information obtained from the auxiliary signs 12 in the event that the aircraft 100 deviates from the landing site 10 or its designated route 20. For example, if the auxiliary signs 12 are placed on a circle around the landing site 10, and the distance between adjacent auxiliary signs is less than or equal to the sign-capturable range at the altitude of the aircraft 100, the aircraft 100 entering the circle with the auxiliary signs 12 will be able to smoothly move toward the landing site 10. Even if the aircraft moves out of the circle due to an equipment malfunction or failure, it can capture the auxiliary signs 12 before it moves out of the circle, so it will not inadvertently leave the landing site 10, thus limiting the range of the crash or landing if it is unavoidable.

The auxiliary sign 12 has information that enables the aircraft 100 to obtain the direction in which it should go, and the aircraft 100 that captures auxiliary sign 12 can move in the direction of the landing site 10 even when estimating its own position by GNSS or other methods is difficult. Here, the method of self-position estimation is not limited to GNSS, but may be estimated by radio reception from a ground reference station (RTK, control, etc.), by image or light (VisualSLAM, LidarSLAM, etc.), or by reference to pre-stored terrain or environmental data.

The aircraft 100 may further utilize existing structures other than the auxiliary signs 12 to reach the auxiliary signs 12. The use of structures other than the auxiliary signs 12 makes supplementing the auxiliary signs 12 more convenient while reducing the overall number of auxiliary signs 12 and reducing the cost of installing equipment.

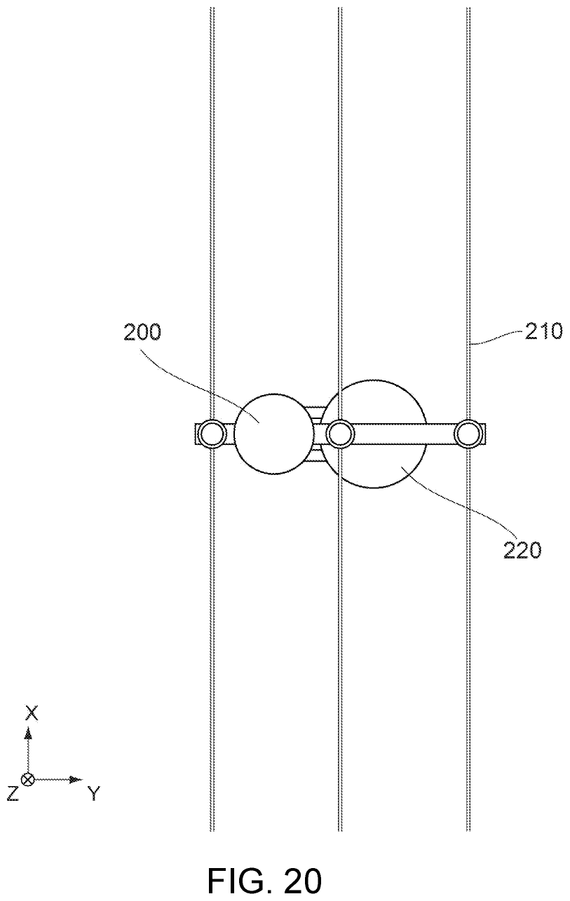

For example, as shown in FIG. 20, when a telephone pole 200, an electric wire 210, a transformer 220, etc. are captured from the sky, it is possible to read a shape that is a combination of circles and lines. Since poles and wires are standardized in size and spacing, the system can be expected to be used for supplementary purposes, such as flying in the direction of a continuation of the wires, using the poles as a reference point and relying on the linear shape of the wires.

After taking off from the takeoff point, the aircraft 100 flies autonomously along a predetermined designated route 20 toward the landing site 10, based on its own position acquired by GNSS or other means, and lands at the landing site 10, such as a port or helipad.

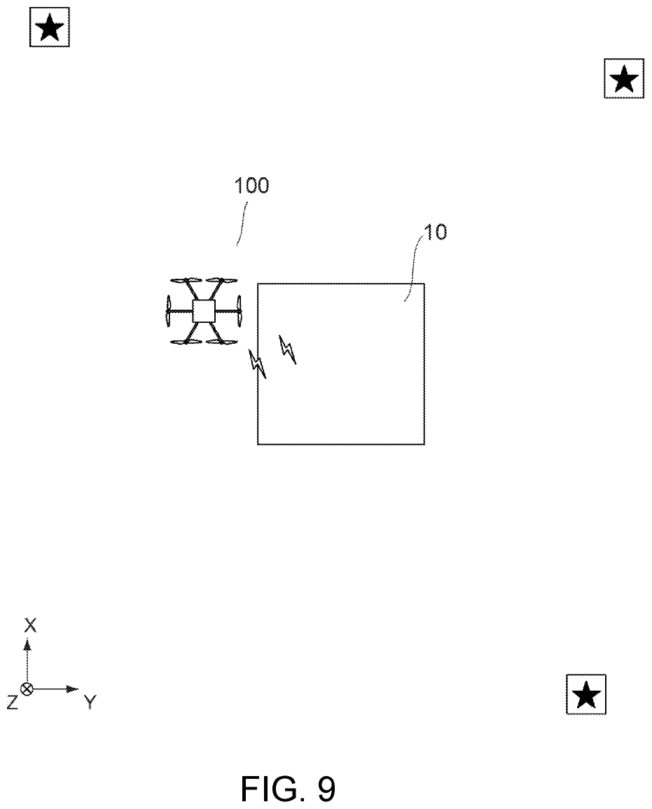

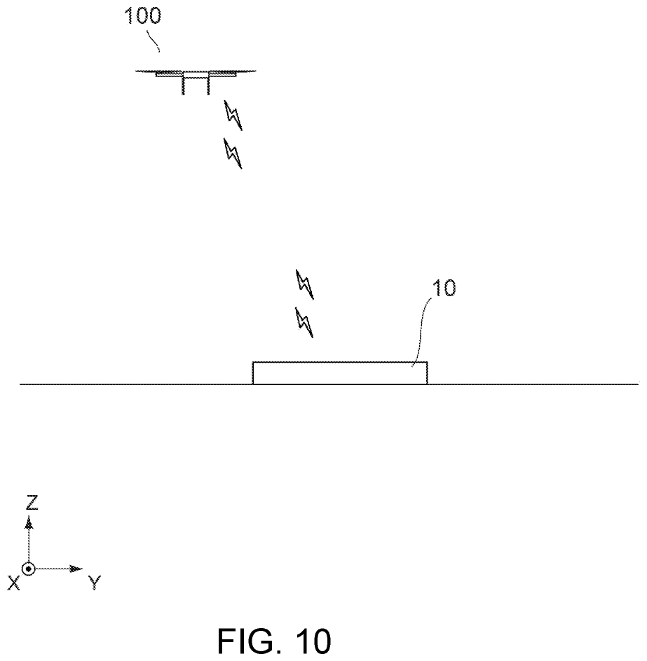

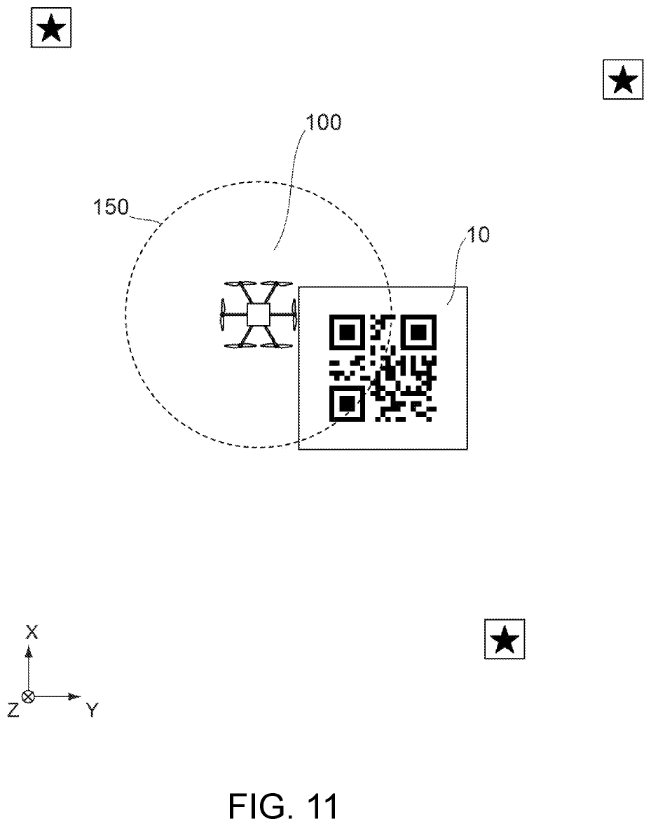

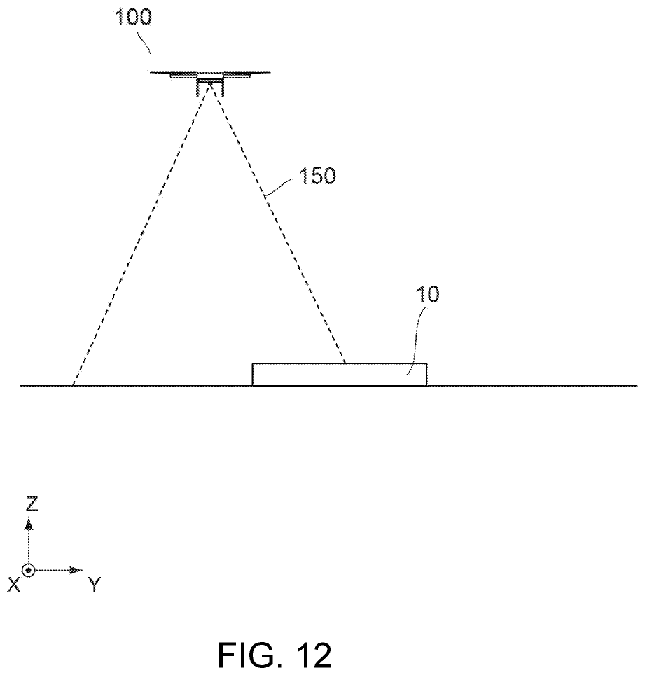

As shown in FIG. 9-12, the aircraft 100 can make a precise autonomous landing at the landing site 10 by using guidance signals from the ground and markers to assist in autonomous landing. In the method using signals from the ground shown in FIG. 9-10, when the aircraft 100 enters the range where the guidance signals can be received, the receiving device equipped by the aircraft 100 acquires the guidance signals (instruction signals) from the ground and performs the landing operation. In the method using an auxiliary marker shown in FIG. 11-12, the aircraft 100 reads the marker 11 and performs the landing operation when the aircraft 100 approaches a distance where the optical sensor such as a camera equipped with the aircraft 100 can recognize the marker 11.

If there is an error in the self-position acquired by GNSS, etc. (for example, the position error acquired by the aircraft 100 becomes large due to a lack of the number of satellites that can be acquired, solar activity, etc.), accurate autonomous flight is not possible, and the aircraft 100 cannot approach the range where it can receive signals provided by the landing equipment or recognize the marker 11 provided by the landing equipment. If the error is several tens of meters, the aircraft 100 will have difficulty proceeding along the designated route 20.

The aircraft 100, which is no longer able to fly accurately autonomously, obtains information on which direction it should head in order to reach the landing site 10 or the designated route 20 by capturing the auxiliary signs 12 located in the vicinity of the landing site 10 or the designated route 20. If the information provided by the auxiliary signs 12 to the aircraft 100 is directional information to the landing site 10, the aircraft can start moving without any information such as self-position or direction. If necessary, the information provided by the auxiliary sign 12 to the aircraft 100 may include distance information to the landing site 10.

Furthermore, the aircraft 100 may transmit the information indicated by the acquired auxiliary signs 12 to, for example, a management server that supports autonomous flight for the aircraft 100 or a processor that other aircraft have. This makes it possible to know how the aircraft 100, which has difficulty proceeding along the designated route 20, will fly after this, and thus avoid contact with other aircraft. If other aircraft are also having difficulty proceeding along the designated route 20 due to the same or similar causes, they can cooperate with each other to make a landing. Furthermore, by including the identification ID and positional information of the auxiliary signs 12 as information indicated by the acquired auxiliary signs 12, it is possible to ascertain which position the aircraft 100 is currently flying.

As shown in FIG. 4, if there are multiple auxiliary signs 12, there is a greater likelihood that the aircraft 100 will be able to capture the auxiliary signs 12. If, at the stage of selecting the 20 designated route, the route is unavoidably located in a valley where satellite supplementation is expected to be difficult or near high-rise buildings, the reliability of autonomous flight can be improved by arranging the auxiliary signs 12 in advance so that they can be easily captured.

When the aircraft 100 determines that accurate autonomous flight has become difficult, it may switch to a flight method (auxiliary sign search mode) to capture the auxiliary sign 12 more quickly. Examples of flight methods include, but are not limited to, flying in a circle from the current point and gradually increasing the diameter of the circle, increasing altitude on the spot, and returning to the direction of the auxiliary sign 12 if it is found in images acquired in the past (such as a few seconds or minutes ago).

### Details of the Second Embodiment

In the details of the second embodiment of this invention, components that overlap with those of the first embodiment operate in the same manner, so they will not be described again.

Auxiliary sign 12 can handle any information that a graphic, text string, bar code, etc. can hold and thus can have the role of a flight assistance in the event that the aircraft 100's self-position estimation is impaired. Thus, the information indicated by the auxiliary sign 12 could be, for example, altitude, speed, direction, movement instructions, or the transmission of coordinate information.

The aircraft 100 may be equipped with a safe landing mode using the auxiliary sign 12 in the event that it becomes impossible to continue autonomous flight on the designated route 20, such as when the satellite is disabled by strong solar flares or other solar activity during flight and cannot estimate its own position using GNSS, etc., or when the aircraft 100 breaks down or is disabled.

In existing radio-controlled aircraft and multicopters, there are models that can be set to switch to a predetermined operation, such as flying while maintaining height, returning to a predetermined point (home position, etc.) using GNSS, etc., or remaining in place when communication with the transmitter (radio) is lost. In the 100 aircraft that performs autonomous flight, it is also necessary to ensure the safety of the aircraft and its surroundings by switching to a predetermined operation when there is a failure in the acquisition of GNSS, etc., which serves as flight guidance.

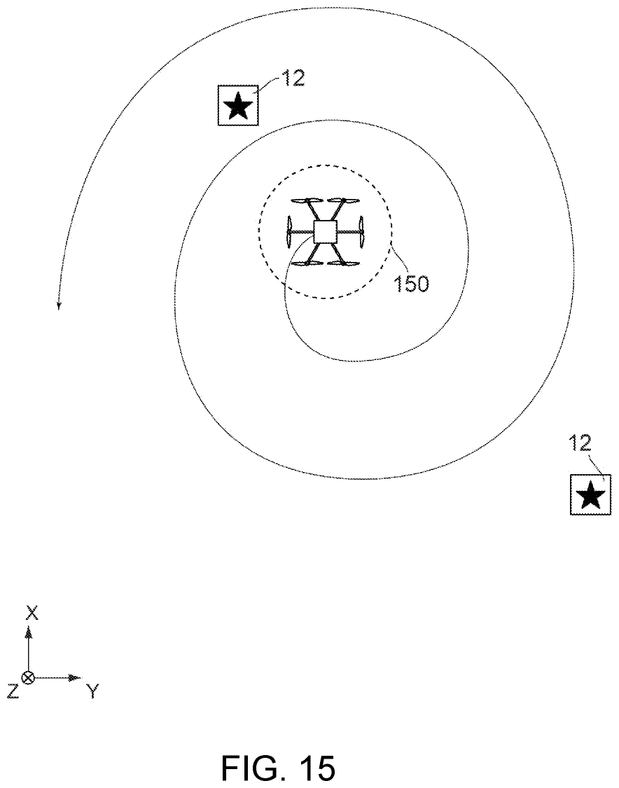

Therefore, the autonomous flight assistance equipment of this invention is equipped with a flight mode that enables landing at a safe site (hereinafter collectively referred to as “safe landing mode”). For example, when self-position estimation by GNSS, etc. becomes impossible, the aircraft 100 switches to the safe landing mode automatically or by external instructions. If the flight method in the safe landing mode is for the aircraft 100 to maintain a predetermined altitude and gradually increase the diameter of the turn as shown in FIG. 15, the aircraft will continue to turn until the nearest auxiliary sign 12 is detected, and upon recognition of the auxiliary sign 12, the aircraft will follow the information provided by the auxiliary sign 12 to the landing site 10 (including the emergency landing site). If the area surrounding the location of the auxiliary sign 12 can be the landing site 10, the aircraft may land at a location that does not interfere with other aircraft capturing the auxiliary sign (e.g., 2 meters away from the auxiliary sign 12, where no aircraft other than the aircraft itself can be captured, etc.). In this case, as in the above, it is possible to know at which position the aircraft 100 will land by including the identification ID and position information of the auxiliary signs 12 as information indicated by the acquired auxiliary signs 12. In particular, if the aircraft is communicating information with other aircraft, the landing may be made based on the other 12 auxiliary signs, rather than relying on the same 12 auxiliary signs if they are supplemented by similar 12 auxiliary signs.

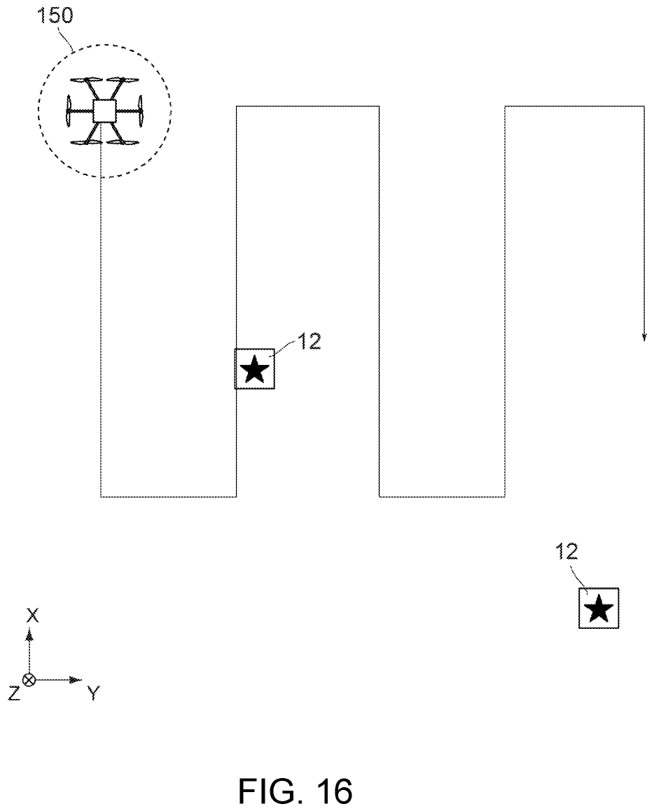

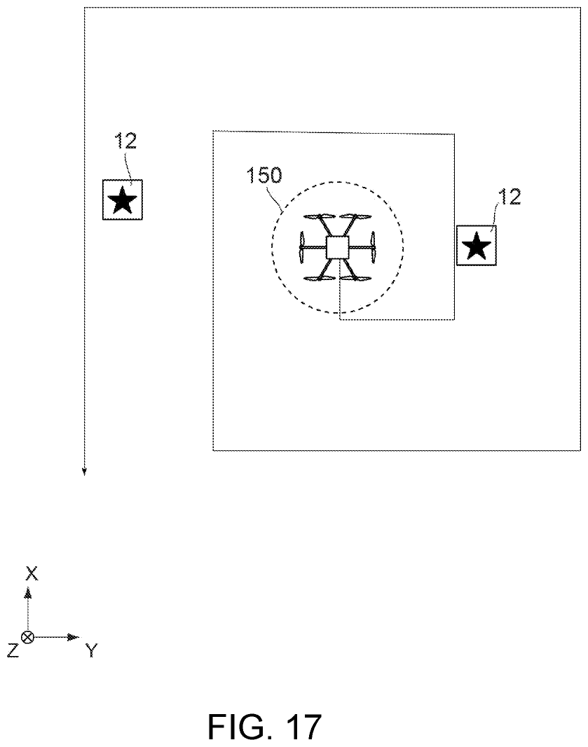

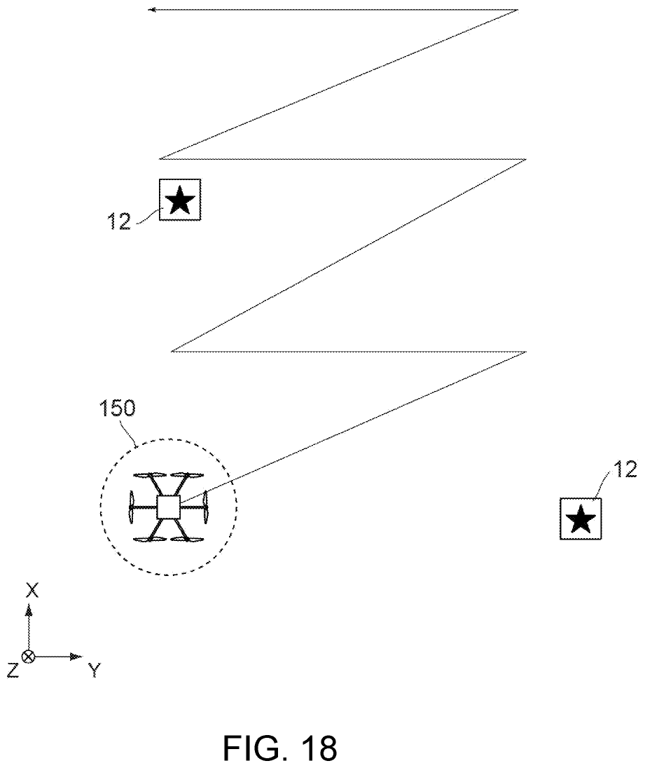

As shown in FIG. 15-FIG. 18, the flight route for the aircraft 100 to capture the auxiliary sign 12 in the safe landing mode can be set arbitrarily. It is expected to supplement the auxiliary sign 12 efficiently by expanding the diameter of the circle in a spiral shape or by shifting its position back and forth, rather than flying in an unplanned manner.

Other examples of flight methods using the safe landing mode include increasing the area that can be acquired by increasing the flight altitude, or looking for objects (e.g., auxiliary signs 12, power lines, poles, etc.) that may be flight assistance from images acquired in the past (e.g., seconds or minutes ago) and flying in the direction of such objects. In the case of using images acquired in the past, for example, if an image containing an object that could be a flight assistance was acquired 10 seconds ago, the direction of travel can be changed 180 degrees and the aircraft can approach the object that could be a flight assistance by moving forward at the same speed for seconds.

The placement of multiple auxiliary signs 12 on or off the designated route 20 of the aircraft 100 allows other aircraft using the same flight path 20 and flying at different locations to receive information on the nearest landing site, should autonomous flight using GNSS or other means become difficult.

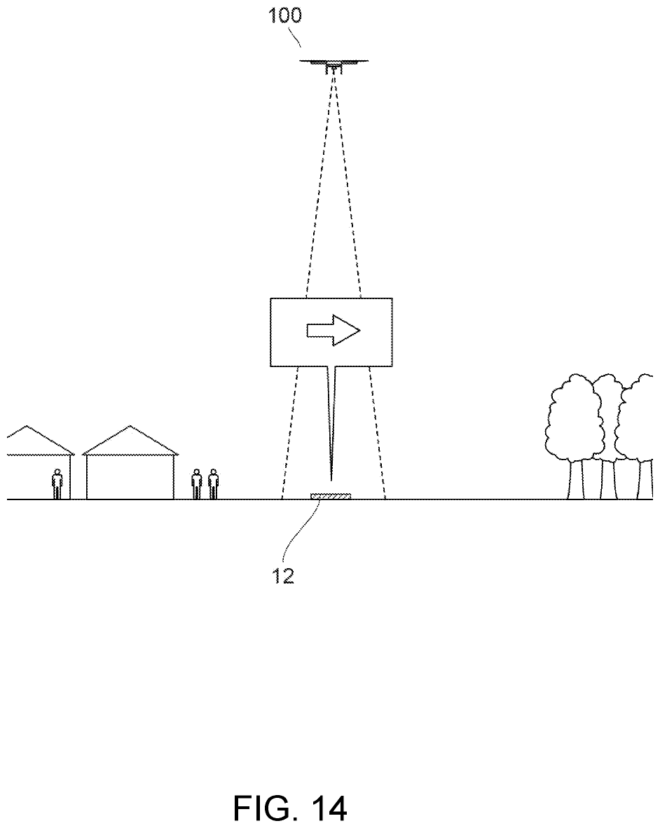

If there are no landing ports or other appropriate facilities around the landing site, or if there are houses or third-party paths between the 12 auxiliary signs and the landing site, as shown in FIG. 14, the direction of the landing site should be in a direction that is less likely to be visited by people or that could reduce the damage from a crash (for example, a vacant lot, riverbed, or forest). In the case of a crash due to a failure to land in time, the direction information can be used to mitigate damage to structures on the ground and to third parties. In normal operation and during the safe landing mode, the aircraft 100 can obtain different information or associate different information with the same auxiliary sign 12 when captured. Specifically, during the safe landing mode, it is acceptable to use an algorithm or reference database that differs from that used in normal operation for the auxiliary sign processing system. This allows, for example, if a black star is captured during normal operation, the direction in which the port is located, and if the same black star is captured during safe landing mode, the direction of the nearest open space can be indicated.

### Details of the Third Embodiment

In the details of the third embodiment of this embodiment, components that overlap with the first and second embodiments operate in the same manner, so they will not be described again.

The auxiliary signs 12 may be transmitted by radio waves, as long as they can inform aircraft of the direction in which they should head. In particular, in locations where it is difficult to provide a sign that is of a size and orientation suitable for reading by aircraft (e.g., narrow areas, steep slopes), or in environments where it is difficult for image sensors to read the 12 auxiliary signs due to wind and rain, a radio station that emits radio waves such as a beacon can be used to assist flight without using a sign.

The aircraft 100, which transmits information using beacons, is equipped with beacon equipment (external information acquisition equipment) used to receive radio waves emitted by beacons installed on the ground.

The above mentioned embodiments are merely examples to facilitate understanding of the invention and are not intended to be construed as limiting the invention. It goes without saying that the invention may be changed and improved without departing from its purpose, and that the invention includes its equivalents.

### DESCRIPTION OF REFERENCE NUMERALS

10 Landing site
11 Landing marker
12 Auxiliary sign
20 Designated route
100 Aircraft
110a-110e Propellers
111a-111e Motors
112 Sensor
150 Sign acquisition range

1. An aircraft flying autonomously on a designated route, comprising a processor that performs flight control of the aircraft based on information about a landing point acquired from an external information acquisition device when the aircraft is not continuing autonomous flight on the specified route.

2. The aircraft according to claim 1,
wherein the external information acquisition device is a sensor.

3. The aircraft according to claim 2,
wherein the sensor is an image sensor.

4. The aircraft according to claim 1,
wherein the external information acquisition device is a beacon device.

5. The aircraft according to claim 1,
wherein the processor executes a search mode in which flight control is performed based on the flight route for acquiring information on the landing site.

6. The aircraft according to claim 1,
wherein the processor recognizes the information on the landing site as the information on the landing site on the designated route during normal times, and wherein the processor recognizes the information on the landing site as information on an emergency landing site different from the landing site on the designated route in the safe landing mode.

7. The aircraft according to claim 1,
wherein the aircraft transmits the information on the landing site to another aircraft or to a management server that supports autonomous flight for the aircraft.

8. A processor mounted on an aircraft flying autonomously on a designated route,
wherein the processor performs flight control of the aircraft based on information on the landing site obtained from an external information acquisition device by the information acquisition device when the autonomous flight over the designated route is not continued.

9. A method for flight control of an aircraft flying autonomously on a designated route,
comprising a step of controlling the flight of the aircraft based on information on the landing site acquired externally by an external information acquisition device when the aircraft is not continuing autonomous flight on the designated route.

10.-11. (canceled)

12. The aircraft according to claim 2,
wherein the processor executes a search mode in which flight control is performed based on the flight route for acquiring information on the landing site.

13. The aircraft according to claim 3,
wherein the processor executes a search mode in which flight control is performed based on the flight route for acquiring information on the landing site.

14. The aircraft according to claim 4,
wherein the processor executes a search mode in which flight control is performed based on the flight route for acquiring information on the landing site.

15. The aircraft according to claim 2,
wherein the processor recognizes the information on the landing site as the information on the landing site on the designated route during normal times, and wherein the processor recognizes the information on the landing site as information on an emergency landing site different from the landing site on the designated route in the safe landing mode.

16. The aircraft according to claim 3,
wherein the processor recognizes the information on the landing site as the information on the landing site on the designated route during normal times, and wherein the processor recognizes the information on the landing site as information on an emergency landing site different from the landing site on the designated route in the safe landing mode.

17. The aircraft according to claim 4,
wherein the processor recognizes the information on the landing site as the information on the landing site on the designated route during normal times, and wherein the processor recognizes the information on the landing site as information on an emergency landing site different from the landing site on the designated route in the safe landing mode.

18. The aircraft according to claim 2,
wherein the aircraft transmits the information on the landing site to another aircraft or to a management server that supports autonomous flight for the aircraft.

19. The aircraft according to claim 3,
wherein the aircraft transmits the information on the landing site to another aircraft or to a management server that supports autonomous flight for the aircraft.

20. The aircraft according to claim 4,
wherein the aircraft transmits the information on the landing site to another aircraft or to a management server that supports autonomous flight for the aircraft.

21. The aircraft according to claim 5,
wherein the aircraft transmits the information on the landing site to another aircraft or to a management server that supports autonomous flight for the aircraft.

22. The aircraft according to claim 6,
wherein the aircraft transmits the information on the landing site to another aircraft or to a management server that supports autonomous flight for the aircraft.
